(19) United States
(12) Patent Application Publication
(10) Pub. No.: US 2014/0009363 A1
(43) Pub. Date: Jan. 9, 2014

(54) WIRELESS ANTENNA MODULE AND METHOD FOR PRODUCING SAME

(71) Applicants: Shinya Takeuchi, Kyoto-shi (JP); Seiichi Yamazaki, Kyoto-shi (JP); Shinji Goma, Nagaokakyo-shi (JP); Kazuya Kato, Nagaokakyo-shi (JP)

(72) Inventors: Shinya Takeuchi, Kyoto-shi (JP); Seiichi Yamazaki, Kyoto-shi (JP); Shinji Goma, Nagaokakyo-shi (JP); Kazuya Kato, Nagaokakyo-shi (JP)

(73) Assignees: Murata Manufacturing Co., Ltd., Kyoto (JP); Nissha Printing Co., Ltd., Kyoto (JP)

(21) Appl. No.: 14/007,795

(22) PCT Filed: Nov. 30, 2011
(86) PCT No.: PCT/JP2011/077631

§ 371 Date: Sep. 26, 2013

(30) Foreign Application Priority Data
Mar. 30, 2011 (JP) 2011-076321

(51) Int. Cl. H01Q 1/12; B29C 45/14

(52) U.S. Cl. CPC H01Q 1/12; B29C 45/14065
USPC 343/872; 264/255

(57) ABSTRACT

A wireless antenna module includes: a housing made of a resin; an electroconductive layer provided on a front surface side of the housing; a top plate provided on a part of the electroconductive layer in a manner so as to be flush with a surface of the electroconductive layer; and a conduction terminal provided on a back surface side of the housing, and electrically connected to the electroconductive layer, passing through the housing, wherein the conduction terminal on the back surface side of the housing is provided in a position opposing the top plate on the front surface side of the housing.

### TECHNICAL FIELD

The present invention relates to a wireless antenna module which is provided on a portable terminal to perform contactless power supply or communication, and a method for producing the wireless antenna module. More particularly, the present invention relates to an antenna module for wireless power transmission or an antenna module for wireless communication, and a method for producing the antenna module.

### BACKGROUND ART

For charging of portable terminals such as mobile phones, personal digital assistants (PDAs), handheld game machines, and digital audio devices, normally, a contact type charging cradle that brings an electrode exposed to a housing of a portable terminal into direct contact therewith or a contactless type charging cradle where an electrode is not exposed to a surface of a housing of a portable terminal is used. At present, as a charging method for the latter contactless type charging cradle, an electromagnetic induction scheme is widely employed as described in Japanese Patent Laid-open Publication No. 2008-300398. In the electromagnetic induction scheme, a power receiving antenna coil is incorporated in, for example, a portable terminal, and power to be transmitted from a power transmitting antenna coil to the power receiving antenna coil is charged to a secondary battery in the portable terminal. In this case, there is a problem with how to incorporate a power receiving antenna coil in a space-saving manner in a portable terminal which has been further miniaturized in recent years.

Hence, it is an effective means that an antenna coil is insert-molded into a housing or a battery pack to form a portable terminal. In this case, when an antenna coil is embedded in a housing by insert molding, it becomes a structural problem how to extract a contact from the embedded antenna coil. On the other hand, there is a method in which for an antenna coil on the front of a housing of a portable terminal, a contactless electrode is provided on the back of the housing, and power received at the power receiving antenna coil provided on the front of the housing is transmitted to the electrode on the back of the housing in a contactless manner as described in WO 2007/094494 A.

In addition, as described above, at present, for a contactless type charging method for a portable terminal, power transmission by an electromagnetic induction scheme is the mainstream. Further, power transmission by an electric field coupling scheme is considered as a new technique as described in Japanese Patent Laid-open Publication No. 2009-531009. The electric field coupling scheme has an advantage in that the shape of power transmitting and receiving antennas does not need to be a coil shape, which is a difference from the electromagnetic induction scheme. Hence, a conductive material, such as copper, in a state of being solid coated (no pattern) can be used as an antenna, and it is also possible to use a transparent electrode of ITO, FTO, etc., as an antenna.

Meanwhile, there is a problem with how to incorporate an antenna for wireless communication in a space-saving manner in a portable terminal which has been miniaturized, such as a mobile phone, a personal digital assistant (PDA), a handheld game machine, and a digital audio device. Hence, it is an effective means that an antenna for wireless communication is insert-molded into a housing to form a portable terminal. In particular, when an antenna for wireless communication having a pattern is embedded in a housing by insert molding, it becomes a structural problem how to extract a contact from the embedded antenna. For example, there is known a method in which in a mobile communication terminal such as a mobile phone, an antenna for wireless communication is insert-molded into a plastic case of the communication terminal by double molding as described in Japanese Patent Laid-open Publication No. 2010-206792. In this case, for extraction of signals from the back of a housing, a projection portion extending in a thickness direction of the antenna is formed in advance, by which extraction of signals from the back is implemented.

### SUMMARY OF THE INVENTION

In wireless power transmission by an electric field coupling scheme such as that described in Japanese Patent Laid-open Publication No. 2009-531009, each of a contactless charger and portable terminal includes an active electrode and a passive electrode. Then, the power transmitting module and the power receiving module are coupled to each other by capacitance occurring between the active electrodes of a power transmitting module of the charger and a power receiving module of the portable terminal and capacitance occurring between the passive electrodes of the power transmitting module and the power receiving module. To increase power transmission efficiency, it is an important factor that the capacitance value between the electrodes is large. Since the power transmission efficiency is affected by the distances between passive electrodes and between active electrodes of the respective antennas of the transmitting and receiving power modules, it is desirable that on either of the power transmitting and receiving sides the antennas be disposed as much as possible on the front sides of the power transmitting module and the power receiving module.

In addition, there is also a structural constraint on how to provide a contact for extracting power from the antenna provided on the front side in the portable terminal. For example, when an electrode connected to an antenna from the front side of a housing of an antenna module is provided, an aesthetic appearance is impaired. In addition, when, as described in WO 2007/094494 A, power is extracted such that a contact is provided on the back side of a housing in contactless mode for an antenna on the front side, power transmission by an electric field coupling scheme in contactless mode is performed in two stages. In particular, power transmission of an electric field coupling scheme is performed between the antenna on the front side of the portable terminal and the contactless contact on the back side across the thickness of the housing, and thus, high transmission efficiency cannot be obtained.

Furthermore, there is also a structural constraint on how to provide a contact for extracting signals from the antenna provided on the front side in the portable terminal. For example, when an electrode connected to an antenna from the front side of the housing of the antenna module is provided, an aesthetic appearance is impaired. In addition, performing double molding as described in Japanese Patent Laid-open Publication No. 2010-206792 leads to inefficiency.

An object of the present invention is to provide a wireless antenna module that does not impair an aesthetic appearance, and a method for producing the wireless antenna module.

A method for producing a wireless antenna module according to a first aspect includes:

preparing a first injection molding mold for forming a front surface side upon molding;

disposing a top plate on an inner surface of the first injection molding mold, the top plate forming a portion of a front surface upon molding;

providing a first electroconductive layer on the top plate; preparing a second injection molding mold paring up with the first injection molding mold in combination and having, at a location facing the top plate, a through hole into which a crimp pin is to be inserted;

inserting a crimp pin into the through hole of the second injection molding mold so as to face the top plate provided on the inner surface of the first injection molding mold;

disposing a conduction terminal in a position on the second injection molding mold where the conduction terminal faces the top plate and where the crimp pin is located adjacent to the conduction terminal;

providing a second electroconductive layer on surfaces of the crimp pin and the conduction terminal that face the top plate;

combining the first injection molding mold and the second injection molding mold together such that the second electroconductive layer provided on the surfaces of the crimp pin and the conduction terminal on the side of the second injection molding mold is crimped onto the first electroconductive layer provided on the top plate on the side of the first injection molding mold;

filling and curing a resin in a cavity portion between the first injection molding mold and the second injection molding mold while the crimp pin is allowed to gradually move backward; and

opening the first injection molding mold and the second injection molding mold to take out an antenna module in which the top plate and the first electroconductive layer are provided in sequence on a front surface side of a housing made of the resin, and the conduction terminal electrically connected to the first electroconductive layer is provided on a back surface side.

Further, as a method for producing a wireless antenna module of a second aspect, in the first aspect, in the step of filing a resin, the crimp pin is allowed to move backward in synchronization with timing of the filling of the resin.

A method for producing a wireless antenna module according to a third aspect includes:

preparing a first injection molding mold for forming a front surface side upon molding;

disposing a top plate on an inner surface of the first injection molding mold, the top plate forming a part of a front surface upon molding;

providing a first electroconductive layer on the top plate;

preparing a second injection molding mold paring up with the first injection molding mold in combination;

disposing a conduction terminal in a position on the second injection molding mold where the conduction terminal faces the top plate;

providing a second electroconductive layer on a surface of the conduction terminal that faces the top plate;

combining the first injection molding mold and the second injection molding mold together such that the second electroconductive layer provided on the surface of the conduction terminal on the side of the second injection molding mold is crimped onto the first electroconductive layer provided on the top plate on the side of the first injection molding mold;

filling and curing a resin in a cavity portion between the first injection molding mold and the second injection molding mold; and

opening the first injection molding mold and the second injection molding mold to take out an antenna module in which the top plate and the first electroconductive layer are provided in sequence on a front surface side of a housing made of the resin, and the conduction terminal electrically connected to the first electroconductive layer is provided on a back surface.

Further, as a method for producing a wireless antenna module of a fourth aspect, in any one of the first to third aspect, the top plate and the second electroconductive layer are aligned so as to face each other.

Further, as a method for producing a wireless antenna module of a fifth aspect, in any one of the first to fourth aspect, the top plate has an area greater than an area of the second electroconductive layer.

Further, as a method for producing a wireless antenna module of a fourth aspect, in any one of the first to fifth aspect, the step of disposing a top plate and the step of providing a first electroconductive layer are performed simultaneously by combining a top plate and a first electroconductive layer together in advance and then disposing the combined top plate and first electroconductive layer on the inner surface of the first injection molding mold.

Further, as a method for producing a wireless antenna module of a sixth aspect, in any one of the first to third aspect, as the first electroconductive layer, a first electroconductive layer having a predetermined area is used, and the wireless antenna module is allowed to function as an antenna module for wireless power transmission.

Further, as a method for producing a wireless antenna module of a eighth aspect, in any one of the first to sixth aspect, as the first electroconductive layer, a first electroconductive layer having a predetermined pattern is used, and the wireless antenna module is allowed to function as an antenna module for wireless communication.

A wireless antenna module according to a ninth aspect includes:

a housing made of a resin;

an electroconductive layer provided on a front surface side of the housing;

a top plate provided on a part of the electroconductive layer in a manner so as to be flush with a surface of the electroconductive layer; and

a conduction terminal provided on a back surface side of the housing, and electrically connected to the electroconductive layer, passing through the housing,

wherein the conduction terminal on the back surface side of the housing is provided in a position facing the top plate on the front surface side of the housing.

Further, as a wireless antenna module of tenth aspect, in the ninth aspect, further includes a decorative film provided on the electroconductive layer.

Further, as a wireless antenna module of eleventh aspect, in the ninth aspect or the tenth aspect, the electroconductive layer is a electroconductive layer having a predetermined area, and the wireless antenna module functions as an antenna module for wireless power transmission.

Further, as a wireless antenna module of twelfth aspect, in the ninth aspect or the tenth aspect, the electroconductive layer is a electroconductive layer having a predetermined pattern, and the wireless antenna module functions as an antenna module for wireless communication.

A portable terminal according to thirteenth aspect includes an antenna module for wireless power transmission of eleventh aspect.

A portable terminal according to fourteenth aspect includes an antenna module for wireless communication according to twelfth aspect.

A portable terminal according to fifteenth aspect includes an antenna module for wireless power transmission according to eleventh aspect;

an antenna module for wireless communication according to twelfth aspect; and

a switching switch that selects either one of the antenna module for wireless power transmission and the antenna module for wireless communication.

In a wireless antenna module and a method for producing the wireless antenna module according to the present invention, upon providing a conduction terminal connected to a first electroconductive layer, on the back surface side of a housing, a top plate which covers a predetermined area including a position of the front surface where the conduction terminal on the back surface side corresponds on the front surface side is disposed in advance.

Normally, when core inserts (a conduction terminal and a second electroconductive layer) are provided into a housing, during cooling time after filling a resin for forming the housing, due to the difference between the overall resin shrinkage ratio and the resin shrinkage ratio of a portion around the core inserts (the conduction terminal and the second electroconductive layer) influenced by the conductive terminal, a copper foil, etc., provided on the back surface side of the housing, shape failures (sink marks) such as dents in the resin occur in a top surface of the housing.

In the wireless antenna module and the method for producing the wireless antenna module according to the present invention, by providing the top plate in advance in a position of the front surface where the conduction terminal on the back surface side corresponds on the front surface side in the above-described manner, the occurrence of shape failures (sink marks) in a top surface of the housing upon curing a resin can be suppressed.

### BRIEF DESCRIPTION OF THE DRAWINGS

The present invention will become readily understood from the following description of preferred embodiments thereof made with reference to the accompanying drawings, in which like parts are designated by like reference numeral and in which:

FIG. 1 is a schematic cross-sectional view showing a cross-sectional structure of a wireless antenna module according to a first embodiment of the present invention;

FIG. 2A is a schematic diagram showing configurations of a conduction terminal and a second electroconductive layer which are core inserts, and FIG. 2B is a schematic diagram showing a configuration of only the conduction terminal;

FIG. 3 is a schematic cross-sectional view showing a cross-sectional structure from a top plate to a first electroconductive layer;

FIG. 4 is a schematic cross-sectional view showing a cross-sectional structure from a top plate to a first electroconductive layer in a variant;

FIG. 5 is a schematic diagram showing the occurrence of shape failures (sink marks) in a comparative example for the case of not providing a top plate;

FIG. 6A is a side cross-sectional view of a portable terminal that includes the wireless antenna module according to the first embodiment as an antenna module for wireless power transmission, and FIG. 6B is a plan view of the portable terminal;

FIG. 7A is a plan view of a portable terminal that includes the wireless antenna module according to the first embodiment as an antenna module for wireless communication, and FIG. 7B is a side cross-sectional view of the portable terminal;

FIGS. 8A to 8D are schematic diagrams showing the steps of a method for producing a wireless antenna module, according to the first embodiment of the present invention;

FIG. 9 is a schematic cross-sectional view showing a cross-sectional structure of a wireless antenna module according to a second embodiment of the present invention;

FIG. 10 is a schematic perspective view showing an electrical connection between a pull-out portion from a first electroconductive layer in FIG. 9 and a conduction terminal;

FIGS. 11A to 11D are schematic diagrams showing the steps in a variant of a method for producing a wireless antenna module, according to a third embodiment of the present invention;

FIG. 12A is a schematic diagram of an example of a curved shape with an upward convex surface which is one variant of a wireless antenna module according to an embodiment of the present invention, and FIG. 12B is a schematic diagram of an example of a curved shape with a saddle-shaped surface; and

FIG. 13A is a wiring line diagram for when, in the case of using a wireless antenna module according to a fourth embodiment of the present invention as both an antenna module for wireless power transmission and an antenna module for wireless communication, the wireless antenna module is used as an antenna module for wireless power transmission, and FIG. 13B is a wiring line diagram for when the wireless antenna module is used as an antenna module for wireless communication.

### DETAILED DESCRIPTION OF THE EMBODIMENTS

Wireless antenna modules and methods for producing the wireless antenna modules, according to embodiments of the present invention will be described using the accompanying drawings. Note that in the drawings substantially the same members are denoted by the same reference numerals.

### First Embodiment

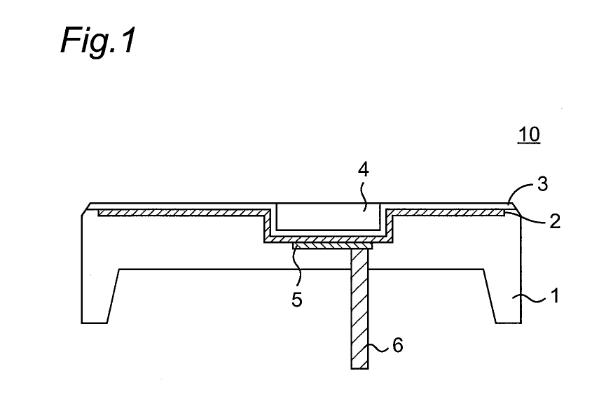

FIG. 1 is a schematic diagram showing an outline of a wireless antenna module 10 according to a first embodiment. The wireless antenna module 10 includes: a housing 1 made of a resin; a first electroconductive layer 2 provided on the front surface side of the housing 1 and functioning as an antenna; a decorative film 3 provided on the first electroconductive layer 2; a top plate 4 provided on a portion of the decorative film 3 so as to be flush with a surface of the decorative film 3; and a conduction terminal 6 provided on the back surface side of the housing 1 and electrically connected to the first electroconductive layer 2, passing through the housing 1. Note that the conduction terminal 6 is electrically connected to the first electroconductive layer 2 through a second electroconductive layer 5. Note also that the conduction terminal 6 on the back surface side of the housing 1 is provided in a position where the conduction terminal faces the top plate 4 on the front surface side of the housing 1.

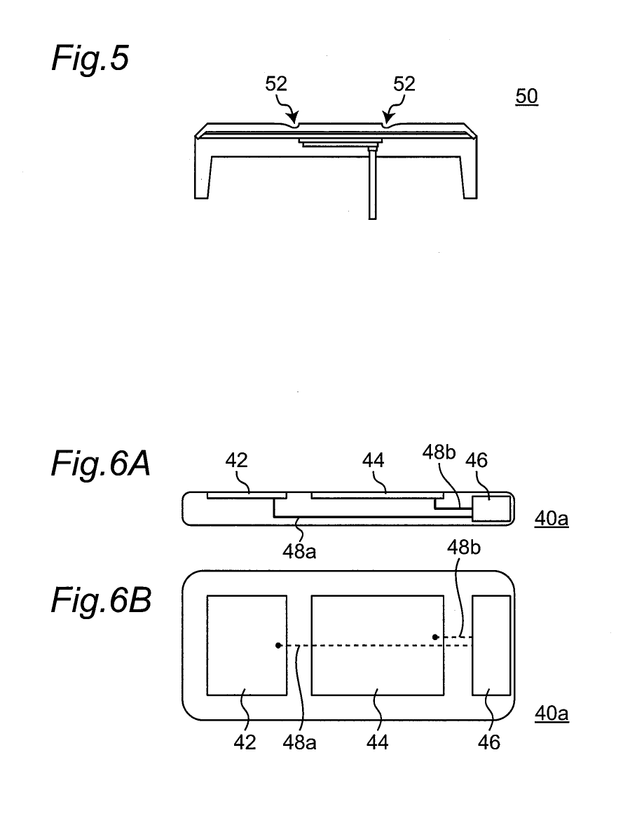

In the wireless antenna module 10 according to the first embodiment, upon providing the conduction terminal 6 connected to the first electroconductive layer 2, on the back surface side of the housing 1, the top plate 4 which covers a predetermined area including a position of the front surface where the conduction terminal 6 on the back surface side corresponds on the front surface side is disposed in advance. Normally, when core inserts (the conduction terminal 6 and the second electroconductive layer 5) are provided into the housing 1, as shown in FIG. 5, during cooling time after filling a resin for forming the housing 1, due to the difference between the overall resin shrinkage ratio and the resin shrinkage ratio of a portion around the core inserts (the conduction terminal 6 and the second electroconductive layer 5) influenced by the conductive terminal 6, the second electroconductive layer 5 (copper foil), etc., which are core inserts provided on the back surface side of the housing 1, shape failures (sink marks) 52 such as dents in the resin occur in a top surface of the housing, particularly in the perimeter of the second electroconductive layer 5 which is a core insert, upon curing the resin. The shape failures (sink marks) 52 such as dents cause deformation in the first electroconductive layer 2 and the decorative film 3 on the top of the housing 1 made of a resin. By providing, as described above, the top plate 4 in advance in a position of the front surface where the conduction terminal 6 on the back surface side corresponds on the front surface side, as shown in FIG. 1, the occurrence of shape failures (sink marks) in the top surface of the housing 1 upon curing the resin can be suppressed.

In addition, the wireless antenna module 10 according to the first embodiment can be used as an antenna module for wireless power transmission by using a first electroconductive layer 2 having a predetermined area. The wireless antenna module 10 according to the first embodiment can be used in, for example, both a power transmission system of a parallel plate type electric field coupling scheme (capacitive coupling scheme) and a power transmission system of an asymmetrical type electric field coupling scheme (capacitive coupling scheme).

<Application to a Portable Terminal as an Antenna Module for Wireless Power Transmission>

FIG. 6A is a side cross-sectional view of a portable terminal 40a that includes the wireless antenna module 10 according to the first embodiment as an antenna module for wireless power transmission, and FIG. 6B is a plan view of the portable terminal 40a.

In the portable terminal 40a, an active electrode 42 and a passive electrode 44 are provided on the same front surface side. In addition, a control circuit for power transmission 46 which is connected to the active electrode 42 and the passive electrode 44 by routing wiring lines 48a and 48b is provided. Power transmitted from an external power supply (not shown) through the active electrode 42 and the passive electrode 44 is rectified and smoothed in the control circuit 46 and fed to, for example, a secondary battery (not shown), etc. In this case, it is preferred that the routing wiring line 48a for connecting the active electrode 42 to the control circuit 46 pass through below the passive electrode 44. By this, radiation from the routing wiring line 48a can be guarded by the passive electrode 44. Note that although in the portable terminal 40a the active electrode 42 and the passive electrode 44 are provided on the same front surface side, the configuration is not limited thereto and the active electrode 42 and the passive electrode 44 may be provided on different surfaces.

Furthermore, the wireless antenna module 10 according to the first embodiment can be used as an antenna module for wireless communication by using a first electroconductive layer 2 having a predetermined pattern.

<Application to a Portable Terminal as an Antenna Module for Wireless Communication>

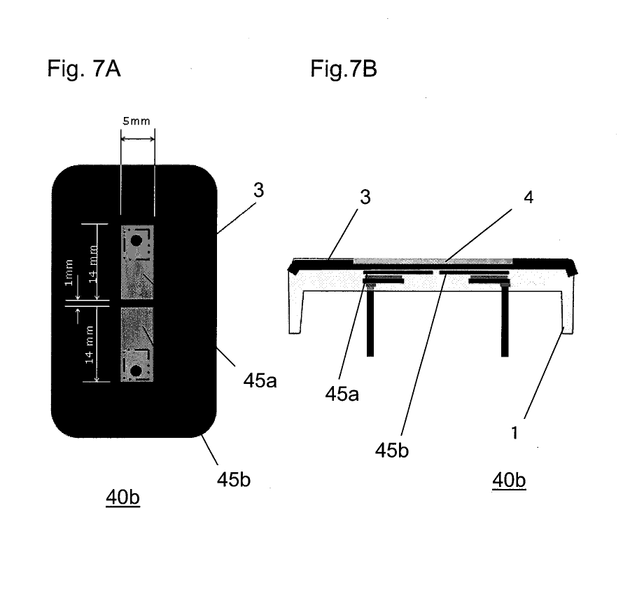

FIG. 7A is a plan view of a portable terminal 40b that includes the wireless antenna module 10 according to the first embodiment as the antenna module for wireless communication 10, and FIG. 7B is a side cross-sectional view of the portable terminal 40b.

In the portable terminal 40b, an antenna 45a and an antenna 45b are provided on the same front surface. Each of the antennas 45a and 45b is 5 mm×14 mm in size and is a copper foil with a thickness of 2.5 mm. In addition, the gap between the antennas 45a and 45b is 1 mm. Note that the above-described numerical values are an example and thus the configuration is not limited thereto. For the antenna pattern, for example, dimensions described in Japanese Patent Publication No. 4067041 B1, etc., may be employed, in addition, for the antenna pattern, a pattern that can function as an antenna for wireless communication and that supports a usage frequency can be used.

The components composing the wireless antenna module 10 according to the first embodiment will be described below.

<Housing>

The housing 1 supports the entire wireless antenna module 10 and supports particularly the portion of the first electroconductive layer 2 which serves as an antenna. For the housing 1, a thermosetting resin, a thermoplastic resin, or a radiation curable resin can be used. In addition, the housing 1 may be molded by injection molding.

<First Electroconductive Layer>

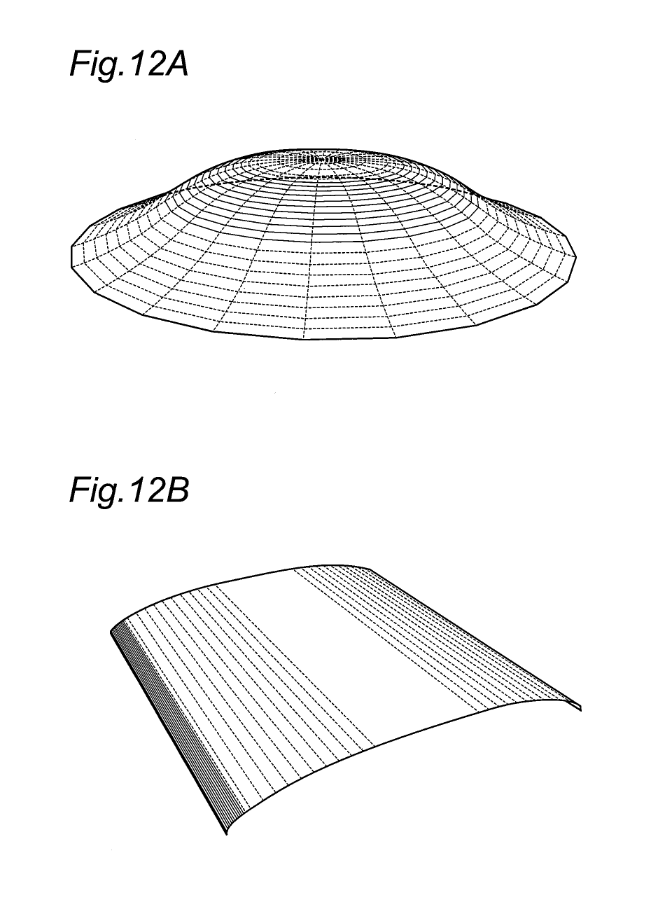

The first electroconductive layer 2 may be any electroconductive layer, and the surface shape may be either a planar shape or a curved shape. For example, a curved shape such as that shown in FIG. 12A or 12B may be used. Note that FIGS. 12A and 12B each show an outline of a surface including the portion of the top plate 4 of the wireless antenna module 10. In addition, the first electroconductive layer 2 may be a transparent electroconductive layer of ITO, FTO, etc., or a metal layer such as a copper foil or a gold foil. Note that the thickness of the first electroconductive layer 2 is preferably 10 nm to 1 μm in the case of a transparent electroconductive layer of ITO, FTO, etc., and is preferably 3 to 50 μm in the case of a copper foil. In addition, the sheet resistance of the first electroconductive layer 2 ranges from 0 Ω/□ to 1000 Ω/□.

Note that the number of first electroconductive layers 2 provided in one wireless antenna module 10 is not limited to one; for example, as shown in the example of the portable terminal 40 in FIG. 6A, two or more first electroconductive layers 2 may be provided.

The first electroconductive layer 2 can be allowed to function as a power receiving antenna for power transmission by using, for example, such a first electroconductive layer 2 that is solid coated with no pattern and that has a predetermined area. In this case, the wireless antenna module 10 can be allowed to function as an antenna module for wireless power transmission.

In addition, the first electroconductive layer 2 can be used as a passive electrode for an electric field coupling scheme (capacitive coupling scheme). Since the first electroconductive layer 2 can be formed as a large-area electrode over the front surface of the housing 1, when the first electroconductive layer 2 is used as a passive electrode of a power receiving module, a large capacitance can be formed between the passive electrode and a passive electrode of a power transmitting module. Hence, transmittable power can be increased. Note that the first electroconductive layer 2 may be used as an active electrode for an electric field coupling scheme.

Furthermore, the first electroconductive layer 2 can be allowed to function as an antenna for communication by using such a first electroconductive layer 2 that has a pattern for communication. In this case, the wireless antenna module 10 can be allowed to function as an antenna module for wireless communication.

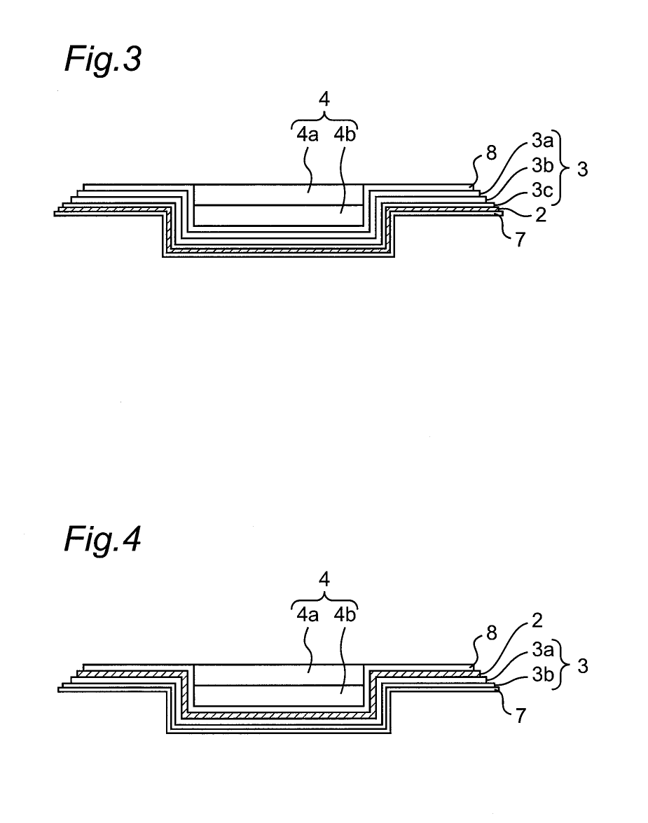

Moreover, as shown in, for example, FIG. 3, an adhesive layer 7 for obtaining excellent adhesiveness to a resin for forming the housing 1 may be applied to a side of the first electroconductive layer 2 that faces the side of the housing 1. In this case, it is preferred that the adhesive layer 7 not be applied to a portion for establishing an electrical connection between the second electroconductive layer 5 and the conduction terminal 6.

<Decorative Film>

The decorative film 3 is provided to decorate the external appearance of the wireless antenna module 10. It is preferred that the decorative film 3 have insulation properties. By the decorative film 3, the first electroconductive layer 2 can be protected and the insulation properties on the front surface side can be secured. Furthermore, the decorative film 3 is not limited to a single-layer structure. For example, as shown in FIG. 3, the decorative film 3 may have a three-layer structure including a decorative layer 3a, a base film 3b, and an adhesive layer 3c. Note that a protective layer 8 may be provided on a surface, if necessary.

Note that the decorative film 3 does not necessarily need to be provided on the front surface side, and as shown in a variant in FIG. 4, a transparent electroconductive layer may be provided on the front surface side as a first electroconductive layer 2, and a decorative film 3 may be provided below the first electroconductive layer 2. In this case, the first electroconductive layer 2 is exposed to the front surface of the housing. Hence, a protective layer 8 may be provided on the first electroconductive layer 2, if necessary. In addition, in order to ensure an electrical connection between the first electroconductive layer 2 and the conductive terminal 6, an opening may be provided in a portion of the decorative film 3 corresponding to an electrical connection portion between the first electroconductive layer 2 and the core inserts which are the conductive terminal 6 and the second electroconductive layer 5, if necessary.

<Top Plate>

For the top plate 4, woods such as bamboo, white oak, horse chestnut, oak, and Afrormosia, resins such as polycarbonate, ABS, and PMMA, or metals such as aluminum and stainless can be used. In addition, the plate thickness of the top plate 4 is preferably in the range of 0.1 to 0.3 mm and more preferably 0.2 mm. In addition, the longitudinal elastic modulus of a plate material of the top plate 4 is preferably in the range of 2 to 70 GPa and more preferably in the range of 4 to 70 GPa. Furthermore, the material reflectance of the top plate 4 is preferably in the range of 30 to 70% and more preferably in the range of 40 to 50%.

In addition, the top plate 4 preferably has an area greater than or equal to at least 10% of the projected area of the core inserts which are the conductive terminal 6 and the second electroconductive layer 5 onto the front surface side of the housing, and more preferably has an area greater than or equal to 20%. By thus allowing the top plate 4 to have an area greater than the projected area of the core inserts, the occurrence of sink marks such as dents in a front surface portion corresponding to an extension portion of the core inserts due to the influence of the core inserts provided on the back surface side can be suppressed. Note that it is more preferred that the top plate 4 be provided to cover the entire projected portion of the core inserts onto the front surface side.

Note that the top plate 4 is not limited to a single structure; for example, as shown in FIG. 3, the top plate 4 may be formed by a two-layer structure of a top plate main body 4a and a non-woven fabric cloth 4b. The non-woven fabric cloth 4b can be used, for example, for adhesion to the decorative film 3. In the case of FIG. 3, for example, the thickness of the top plate main body 4a is 0.2 mm, and the thickness of the non-woven fabric cloth 4b is 0.05 mm. In addition, a surface of the top plate 4 may have a curved shape, as shown in an outline of a surface including the portion of the top plate 4 of the wireless antenna module 10 in FIGS. 12A or 12B. In this case, the decorative film 3, etc., are disposed such that their surfaces are also flush with the surface of the top plate 4.

<Core Inserts>

In the wireless antenna module 10, the conduction terminal 6 electrically connected to the first electroconductive layer 2 which is provided on the front surface side of the housing 1 and which functions as an antenna is provided on the back surface side of the housing 1. Note that the conduction terminal 6 and the second electroconductive layer 5 for electrically connecting the conduction terminal 6 to the first electroconductive layer 2 are referred to as core inserts. Upon forming the housing 1, core inserts including the conduction terminal 6 and the second electroconductive layer 5 are provided in advance on the inside of an injection molding mold, and then, a resin is filled and cured in a cavity portion of the injection molding mold to form the housing 1, by which the conduction terminal 6 can be provided on the back surface side of the housing 1.

<Conduction Terminal>

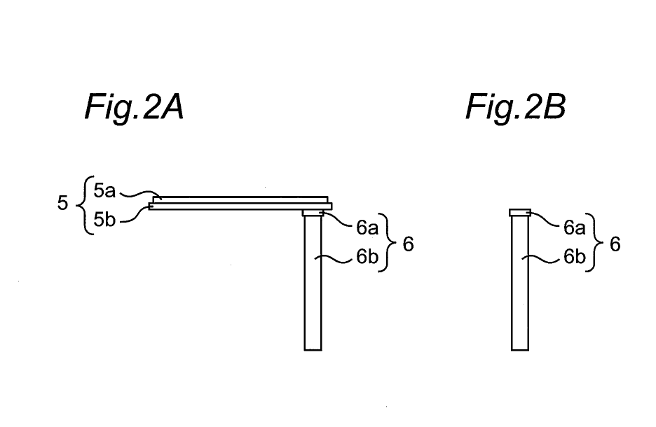

The conduction terminal 6 is a terminal that is electrically connected to the first electroconductive layer 2 and that is drawn from the back surface side of the housing 1. The conduction terminal 6 may be any conductive terminal. For example, as shown in FIGS. 2A and 2B, the conduction terminal 6 may be composed of a conductive pin 6b and an anisotropic conductive film 6a on top of the conductive pin 6b.

<Second Electroconductive Layer>

The second electroconductive layer 5 is used to electrically connect the conduction terminal 6 to the first electroconductive layer 2. As with the first electroconductive layer 2, the second electroconductive layer 5 may be a transparent electroconductive layer of ITO, FTO, etc., or a metal layer such as a copper foil or a gold foil. In addition, the second electroconductive layer 5 is not limited to a single-layer structure. For example, as shown in FIG. 2A, the second electroconductive layer 5 may have a two-layer structure of an anisotropic conductive film 5a and a copper foil 5b. Note that as shown in FIG. 2B, as a core insert, only a conduction terminal 6 may be provided without providing a second electroconductive layer.

Note that it is preferred that the total thickness of the above-described first electroconductive layer 2, decorative film 3, second electroconductive layer 5, etc., be less than or equal to about 0.1 mm.

<Method for Producing a Wireless Antenna Module>

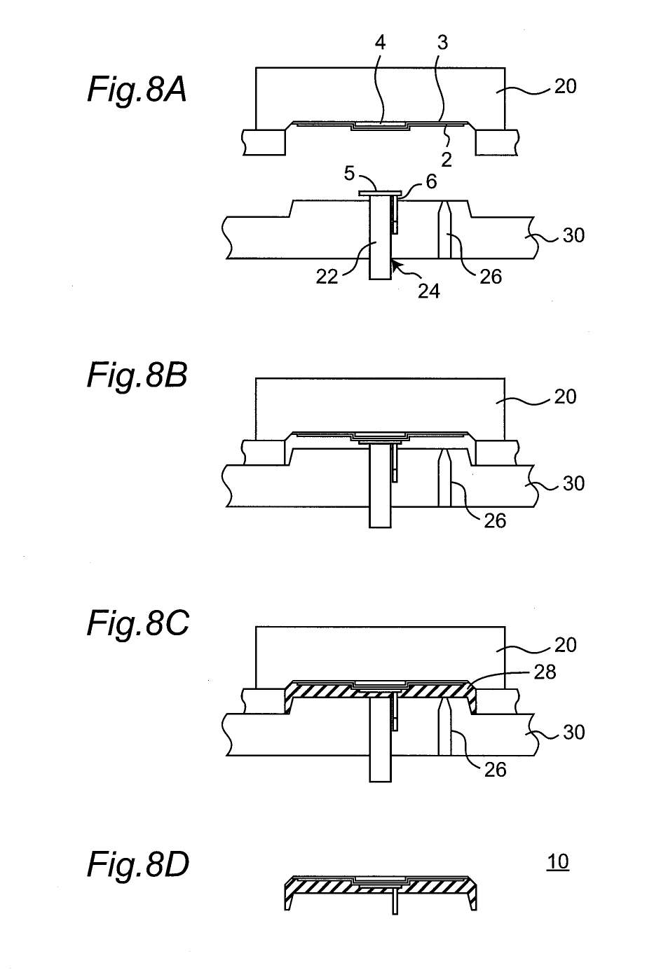

Next, a method for producing a wireless antenna module, according to the first embodiment will be described. FIGS. 8A to 8D are schematic diagrams showing the steps of a method for producing a wireless antenna module, according to the first embodiment.

(1) A top plate 4 which forms a part of a front surface upon molding is disposed on an inner surface of a first injection molding mold 20 for forming the front surface side upon molding. Furthermore, a decorative film 3 is disposed on the inner surface of the first injection molding mold 20 including the top plate 4. After that, a first electroconductive layer 2 is provided on the decorative film 3 (FIG. 8A). Note that for example, as shown in FIG. 3, an adhesive layer 7 for obtaining excellent adhesiveness to a resin for forming a housing 1 may be applied to a side of the first electroconductive layer 2 that faces the side of the housing 1. In this case, it is preferred that the adhesive layer 7 not be applied to a portion for establishing an electrical connection between a second electroconductive layer 5 and a conduction terminal 6.

(2) A second injection molding mold 30 is prepared which pairs up with the first injection molding mold 20 in combination and which has, at a location facing the top plate 4, a through hole 24 into which a crimp pin 22 is to be inserted. The crimp pin 22 is inserted into the through hole 24 of the second injection molding mold 30 so as to face the top plate 4 provided on the inner surface of the first injection molding mold 20. A conduction terminal 6 is disposed in a position on the second injection molding mold 30 where the conduction terminal 6 faces the top plate 4 and where the crimp pin 22 is located adjacent to the conduction terminal 6. A second electroconductive layer 5 is provided on surfaces of the crimp pin 22 and the conduction terminal 6 that face the top plate 4 (FIG. 8A).

(3) The first injection molding mold 20 and the second injection molding mold 30 are combined together such that the second electroconductive layer 5 provided on the surfaces of the crimp pin and the conduction terminal 6 on the side of the second injection molding mold 30 is crimped onto the first electroconductive layer 2 provided on the top plate 4 on the side of the first injection molding mold 20 (FIG. 8B).

(4) A resin 28 is filled in a cavity portion between the first injection molding mold 20 and the second injection molding mold 30 while the crimp pin 22 is allowed to gradually move backward from the cavity portion, and then the resin 28 is cured (FIG. 8C). Note that when a resin is filled, the crimp pin 22 may be allowed to move backward in synchronization with the timing of the filling of the resin 28.

(5) The first injection molding mold 20 and the second injection molding mold 30 are opened to take out an antenna module 10 in which the first electroconductive layer 2, the decorative film 3, and the top plate 4 are provided in sequence on the front surface side of the housing 1 made of a resin which is obtained by curing the resin 28, and the conduction terminal 6 electrically connected to the first electroconductive layer is provided on the back surface side (FIG. 8D).

By the above, the wireless antenna module 10 can be obtained.

Note that in the above-described method, the order of the steps of the method for producing a wireless antenna module is shown such that after disposing the first injection molding mold 20 the second injection molding mold 30 is disposed, but the order is not limited to the one described above. For example, first, the second injection molding mold 30 may be disposed and then the first injection molding mold 20 may be disposed. Alternatively, both of the injection molding molds 20 and 30 may be disposed substantially simultaneously. That is, substantially either of the step of the above-described (1) and the step of (2) may be performed first, or the steps may be performed simultaneously.

Furthermore, in the step of the above-described (1), the top plate 4, the decorative film 3, and the first electroconductive layer 2 are provided in this order on the inner surface of the first injection molding mold 20, but the order is not limited to the one described above. For example, a structure in which the top plate 4, the decorative film 3, and the first electroconductive layer 2 are combined together in advance may be disposed on the inner surface of the first injection molding mold 20.

In the method for producing a wireless antenna module according to the first embodiment, upon providing the conduction terminal 6 connected to the first electroconductive layer 2, on the back surface side of the housing 1, the top plate 4 which covers a predetermined area including a position of the front surface where the conduction terminal 6 on the back surface side corresponds on the front surface side is disposed in advance. By providing the top plate 4 in advance in a position of the front surface where the conduction terminal 6 on the back surface side corresponds on the front surface side in the above-described manner, the occurrence of shape failures (sink marks) 52 in a top surface of the housing 1 upon curing a resin can be suppressed.

(Variant)

FIG. 4 is a schematic cross-sectional view showing a cross-sectional structure from a top plate 4 and a protective layer 8 to a first electroconductive layer 2 and an adhesive layer 7 in a variant of the wireless antenna module according to the first embodiment. In the above-described example, upon providing a first electroconductive layer 2, a top plate 4, a protective layer 8, a decorative film 3 (a decorative layer 3a, a base film 3b, and an adhesive layer 3c), a first electroconductive layer 2, and an adhesive layer 7 are stacked on top of one another in this order. On the other hand, in the variant, a top plate 4, a protective layer 8, a first electroconductive layer 2, a decorative film 3 (a decorative layer 3a and a base film 3b), and an adhesive layer 7 are stacked on top of one another in this order, which is a difference from the above-described example. Note that on a surface of the decorative film 3 provided to cover the first electroconductive layer 2, an opening is provided in a location for establishing an electrical connection between a second electroconductive layer 5 and a conduction terminal 6, to allow the first electroconductive layer 2 to be exposed.

Note that when the first electroconductive layer 2 is exposed to a surface, the first electroconductive layer 2 cannot be used as an active electrode of a power transmission system of an electric field coupling scheme, but can be used as a passive electrode. Note that a protective layer 8 may be provided on the first electroconductive layer 2 exposed to a surface.

### Second Embodiment

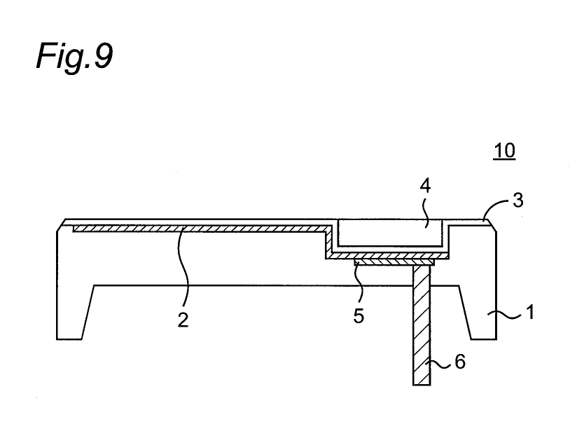

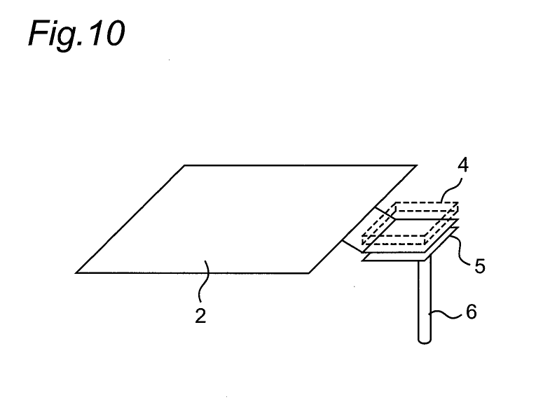

FIG. 9 is a schematic cross-sectional view showing a cross-sectional configuration of a wireless antenna module according to a second embodiment. FIG. 10 is a schematic perspective view showing a connection between a pull-out portion from a first electroconductive layer 2 in FIG. 9 and a conduction terminal 6. The wireless antenna module differs from a wireless antenna module according to the first embodiment in that the conduction terminal 6 is provided as shifted from immediately below the first electroconductive layer 2 functioning as an antenna, but is provided displaced. In this case, the pull-out portion from the first electroconductive layer 2 and the conduction terminal 6 are electrically connected to each other. In addition, a top plate 4 is provided on the top surfaces of core inserts which are the conduction terminal 6 and a second electroconductive layer 5, and is disposed so as to be flush with a surface of the first electroconductive layer.

### Third Embodiment

<Method for Producing a Wireless Antenna Module>

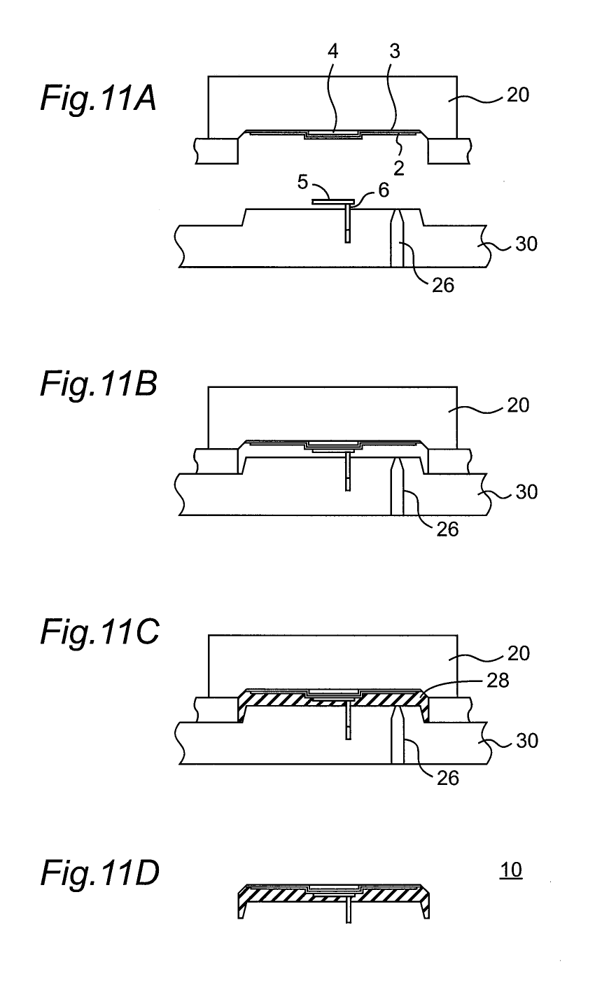

A method for producing a wireless antenna module, according to a third embodiment will be described. FIGS. 11A to 11D are schematic diagrams showing the steps of a method for producing a wireless antenna module, according to the third embodiment. The method for producing a wireless antenna module differs from a method according to the first embodiment in that a conductive terminal 6 is connected to a first electroconductive layer 2 without using a crimp pin.

(1) A top plate 4 which forms a part of a front surface upon molding is disposed on an inner surface of a first injection molding mold 20 for forming the front surface side upon molding. Furthermore, a decorative film 3 is disposed on the inner surface of the first injection molding mold 20 including the top plate 4. After that, a first electroconductive layer 2 is provided on the decorative film 3 (FIG. 11A). Note that for example, as shown in FIG. 3, an adhesive layer 7 for obtaining excellent adhesiveness to a resin for forming a housing 1 may be applied to a side of the first electroconductive layer 2 that faces the side of the housing 1. In this case, it is preferred that the adhesive layer 7 not be applied to a portion for establishing an electrical connection between a second electroconductive layer 5 and a conduction terminal 6.

(2) A second injection molding mold 30 is prepared which pairs up with the first injection molding mold 20 in combination. A conduction terminal 6 is disposed in a position on the second injection molding mold 30 that faces the top plate 4. A second electroconductive layer 5 is provided on a surface of the conduction terminal 6 that faces the top plate 4 (FIG. 11A).

(3) The first injection molding mold 20 and the second injection molding mold 30 are combined together such that the second electroconductive layer 5 provided on the surface of the conduction terminal 6 on the side of the second injection molding mold 30 is crimped onto the first electroconductive layer 2 provided on the top plate 4 on the side of the first injection molding mold 20 (FIG. 11B).

(4) A resin 28 is filled and cured in a cavity portion between the first injection molding mold 20 and the second injection molding mold 30 (FIG. 11C).

(5) The first injection molding mold 20 and the second injection molding mold 30 are opened to take out an antenna module 10 in which the first electroconductive layer 2, the decorative film 3, and the top plate 4 are provided in sequence on the front surface side of the housing 1 made of a resin, and the conduction terminal 6 electrically connected to the first electroconductive layer 2 is provided on the back surface side (FIG. 11D).

By the above, the wireless antenna module 10 can be obtained.

Note that in the above-described method, the order of the steps of the method for producing a wireless antenna module is shown such that after disposing the first injection molding mold 20 the second injection molding mold 30 is disposed, but the order is not limited to the one described above. For example, first, the second injection molding mold 30 may be disposed and then the first injection molding mold 20 may be disposed. Alternatively, both of the injection molding molds 20 and 30 may be disposed substantially simultaneously. That is, substantially either of the step of the above-described (1) and the step of (2) may be performed first, or the steps may be performed simultaneously.

Furthermore, in the step of the above-described (1), the top plate 4, the decorative film 3, and the first electroconductive layer 2 are provided in this order on the inner surface of the first injection molding mold 20, but the order is not limited to the one described above. For example, a structure in which the top //plate 4, the decorative film 3, and the first electroconductive layer 2 are combined together in advance may be disposed on the inner surface of the first injection molding mold 20.

In the method for producing a wireless antenna module according to the third embodiment, too, the same effect as that obtained in the method according to the first embodiment can be obtained. Specifically, by providing the top plate 4 in advance in a position of the front surface side where the conduction terminal 6 on the back surface side corresponds on the front surface side in the above-described manner, the occurrence of shape failures (sink marks) in a top surface of the housing 1 upon curing a resin can be suppressed.

By this, the conduction terminal 6 electrically connected to the first electroconductive layer 2 on the front surface side of the housing 1 can be taken out of the back surface side of the housing 1 without impairing an aesthetic appearance.

### Fourth Embodiment

A wireless antenna module according to a fourth embodiment of the present invention is a wireless antenna module for both power transmission and communication which can be used as both an antenna module for wireless power transmission and an antenna module for wireless communication.

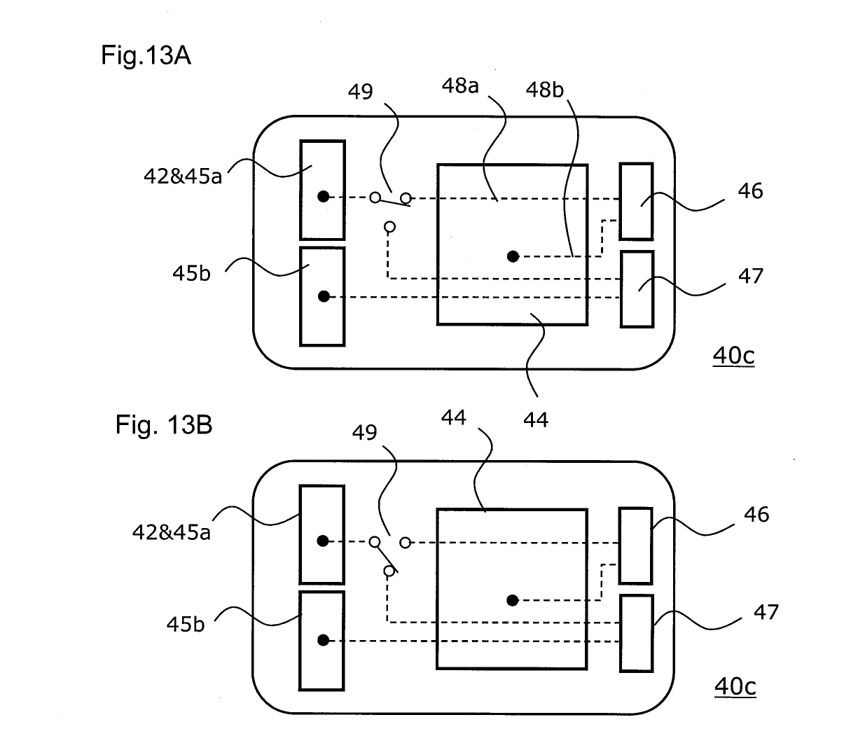

FIG. 13A is a wiring line diagram for when in a portable terminal 40c using a wireless antenna module for both power transmission and communication according to the fourth embodiment of the present invention, the wireless antenna module is used as an antenna module for wireless power transmission. FIG. 13B is a wiring line diagram for when in the portable terminal 40c using the wireless antenna module according to the fourth embodiment of the present invention, the wireless antenna module is used as an antenna module for wireless communication.

The portable terminal 40c includes an active electrode 42, a passive electrode 44, and a control circuit for power transmission 46 connected to the active electrode 42 and the passive electrode 44 by routing wiring lines 48a and 48b, which are used when the wireless antenna module is used as an antenna module for wireless power transmission. In addition, the portable terminal 40c includes two antennas for communication 45a and 45b and a control circuit for communication 47, which are used when the wireless antenna module is used as an antenna module for wireless communication. Note that one component serves as both the active electrode for power transmission 42 and the antenna for communication 45a. Furthermore, the portable terminal 40c includes a switching switch 49 that switches wiring lines according to applications as an antenna module for wireless power transmission and as an antenna module for wireless communication. In the portable terminal 40c, by switching wiring lines by the switching switch 49, the wireless antenna module can be used for two applications as an antenna module for wireless power transmission and as an antenna module for wireless communication.

According to the wireless antenna module for both power transmission and communication according to the fourth embodiment, by switching wiring lines, the wireless antenna module can be used for two applications as an antenna module for wireless power transmission and as an antenna module for wireless communication.

A wireless antenna module according to the present invention can be used as an antenna module for a portable terminal that performs power transmission of an electric field coupling scheme, by using a first electroconductive layer having a predetermined area. In addition, by using a first electroconductive layer having a predetermined pattern, the wireless antenna module can be used as an antenna module for communication.

### DESCRIPTION OF REFERENCE SIGNS

1 Housing

02 First electroconductive layer (antenna)
3 Decorative film
3a Decorative layer
3b Base film
3c Adhesive layer
4 Top plate
4a Top plate main body
4b Non-woven fabric cloth
5 Second electroconductive layer
5a Anisotropic conductive film

05b Copper foil
6 Conduction terminal
6a Anisotropic conductive film
6b Conductive pin
7 Adhesive layer
8 Protective layer
10 Wireless antenna module
20 First injection molding mold
22 Crimp pin
24 Through hole
26 Resin filling opening
28 Resin
30 Second injection molding mold
40a, 40b, 40c Portable terminal
42 Active electrode
44 Passive electrode
45a, 45b Antenna for communication
46 Control circuit for power transmission
47 Control circuit for communication
48a, 48b Routing wiring line
49 Switching switch
50 Wireless antenna module with no top plate (comparative example)
52 Sink mark (shape failure)

1-15. (canceled)

16. A method for producing a wireless antenna module, the method comprising:
preparing a first injection molding mold for forming a front surface side upon molding;
disposing a top plate on an inner surface of the first injection molding mold, the top plate forming a portion of a front surface upon molding;
providing a first electroconductive layer on the top plate;
preparing a second injection molding mold paring up with the first injection molding mold in combination and having, at a location facing the top plate, a through hole into which a crimp pin is to be inserted;
inserting a crimp pin into the through hole of the second injection molding mold so as to face the top plate provided on the inner surface of the first injection molding mold;
disposing a conduction terminal in a position on the second injection molding mold where the conduction terminal faces the top plate and where the crimp pin is located to adjacent to the conduction terminal;
providing a second electroconductive layer on surfaces of the crimp pin and the conduction terminal that face the top plate;
combining the first injection molding mold and the second injection molding mold together such that the second electroconductive layer provided on the surfaces of the crimp pin and the conduction terminal on the side of the second injection molding mold is crimped onto the first electroconductive layer provided on the top plate on the side of the first injection molding mold;
filling and curing a resin in a cavity portion between the first injection molding mold and the second injection molding mold while the crimp pin is allowed to gradually move backward; and
opening the first injection molding mold and the second injection molding mold to take out an antenna module in which the top plate and the first electroconductive layer are provided in sequence on a front surface side of a housing made of the resin, and the conduction terminal electrically connected to the first electroconductive layer is provided on a back surface side.

17. The method for producing a wireless antenna module according to claim 16, wherein in the step of filing a resin, the crimp pin is allowed to move backward in synchronization with timing of the filling of the resin.

18. A method for producing a wireless antenna module, the method comprising:
preparing a first injection molding mold for forming a front surface side upon molding;
disposing a top plate on an inner surface of the first injection molding mold, the top plate forming a part of a front surface upon molding;
providing a first electroconductive layer on the top plate;
preparing a second injection molding mold paring up with the first injection molding mold in combination;
disposing a conduction terminal in a position on the second injection molding mold where the conduction terminal faces the top plate;
providing a second electroconductive layer on a surface of the conduction terminal that faces the top plate;
combining the first injection molding mold and the second injection molding mold together such that the second electroconductive layer provided on the surface of the conduction terminal on the side of the second injection molding mold is crimped onto the first electroconductive layer provided on the top plate on the side of the first injection molding mold;
filling and curing a resin in a cavity portion between the first injection molding mold and the second injection molding mold; and
opening the first injection molding mold and the second injection molding mold to take out an antenna module in which the top plate and the first electroconductive layer are provided in sequence on a front surface side of a housing made of the resin, and the conduction terminal electrically connected to the first electroconductive layer is provided on a back surface.

19. The method for producing a wireless antenna module according to claim 16, wherein the top plate and the second electroconductive layer are aligned so as to face each other.

20. The method for producing a wireless antenna module according to claim 16, wherein the top plate has an area greater than an area of the second electroconductive layer.

21. The method for producing a wireless antenna module according to claim 16, wherein the step of disposing a top plate and the step of providing a first electroconductive layer are performed simultaneously by combining a top plate and a first electroconductive layer together in advance and then disposing the combined top plate and first electroconductive layer on the inner surface of the first injection molding mold.

22. The method for producing a wireless module according to claim 16, wherein as the first electroconductive layer, a first electroconductive layer having a predetermined area is used, and the wireless antenna module is allowed to function as an antenna module for wireless power transmission.

23. The method for producing a wireless module according to claim 16, wherein as the first electroconductive layer, a first electroconductive layer having a predetermined pattern is used, and the wireless antenna module is allowed to function as an antenna module for wireless communication.

24. A wireless antenna module comprising:
a housing made of a resin;
an electroconductive layer provided on a front surface side of the housing;
a top plate provided on a part of the electroconductive layer in a manner so as to be flush with a surface of the electroconductive layer; and
a conduction terminal provided on a back surface side of the housing, and electrically connected to the electroconductive layer, passing through the housing,
wherein the conduction terminal on the back surface side of the housing is provided in a position facing the top plate on the front surface side of the housing.

25. The wireless antenna module according to claim 24, further comprising a decorative film provided on the electroconductive layer.

26. The wireless antenna module according to claim 24, wherein the electroconductive layer is a electroconductive layer having a predetermined area, and the wireless antenna module functions as an antenna module for wireless power transmission.

27. The wireless antenna module according to claim 24, wherein the electroconductive layer is a electroconductive layer having a predetermined pattern, and the wireless antenna module functions as an antenna module for wireless communication.

28. A portable terminal including a wireless antenna module for wireless power transmission according to claim 26.

29. A portable terminal including a wireless antenna module for wireless communication according to claim 27.

30. A portable terminal comprising:
a first wireless antenna module for wireless power transmission including:
a housing made of a resin;
an electroconductive layer provided on a front surface side of the housing;
a top plate provided on a part of the electroconductive layer in a manner so as to be flush with a surface of the electroconductive layer;
a conduction terminal provided on a back surface side of the housing, and electrically connected to the electroconductive layer, passing through the housing,
wherein the conduction terminal on the back surface side of the housing is provided in a position facing the top plate on the front surface side of the housing;
wherein the electroconductive layer is a electroconductive layer having a predetermined area, and the wireless antenna module functions as an antenna module for wireless power transmission;
a second wireless antenna module for wireless communication including:
a housing made of a resin;
an electroconductive layer provided on a front surface side of the housing;
a top plate provided on a part of the electroconductive layer in a manner so as to be flush with a surface of the electroconductive layer;
a conduction terminal provided on a back surface side of the housing, and electrically connected to the electro conductive layer, passing through the housing,
wherein the conduction terminal on the back surface side of the housing is provided in a position facing the top plate on the front surface side of the housing;
wherein the electroconductive layer is a electroconductive layer having a predetermined pattern, and the wireless antenna module functions as an antenna module for wireless communication; and
a switching switch that selects either one of the antenna module for wireless power transmission and the antenna module for wireless communication.
